(19) United States
(12) Patent Application Publication
(10) Pub. No.: US 2014/0289113 A1
(43) Pub. Date: Sep. 25, 2014

(54) SYSTEM AND METHOD FOR A MOBILE CASHIER

(71) Applicant: GLOBAL PAYMENTS INC., Atlanta, GA (US)

(72) Inventor: Dean A. DECRISTOFORO, Las Vegas, NV (US)

(73) Assignee: GLOBAL PAYMENTS INC., Atlanta, GA (US)

(21) Appl. No.: 14/222,129

(22) Filed: Mar. 21, 2014

Related U.S. Application Data
(60) Provisional application No. 61/804,574, filed on Mar. 22, 2013.

(51) Int. Cl. G06Q 50/34; G06Q 20/04; G07F 17/32; G06Q 20/32

(52) U.S. Cl. CPC G06Q 50/34; G06Q 20/3223; G06Q 20/045; G07F 17/3244
USPC 705/42

(57) ABSTRACT

A system for disbursing funds for entertainment includes a portable module that is configured to process customer information. The module is configured to allow the customer to undertake a plurality of transactions, including a quasi-cash transaction. The module includes at least one input device coupled to or formed in the module. The at least one input device is further configured to obtain an electronic endorsement from the customer and to place the electronic endorsement in an electronic image. The module further includes an output device coupled to or formed in the portable module. The output device is configured to create a negotiable instrument for the quasi-cash transaction.

### FIELD OF THE INVENTION

The invention generally relates to the area of payment systems. More particularly, the present invention concerns a system to facilitate transactions for making funds readily available, as well as a method for facilitating such transactions.

### BACKGROUND

Entertainment venues, such as casinos and racetracks, typically provide customers with a number of options for obtaining funds for entertainment activities. For example, entertainment venues typically provide automated teller machines (ATMs) which allow a customer to directly withdraw cash from one of their accounts or request a cash advance using one of their credit cards by inserting either an ATM card or a credit card and entering their PIN (personal identification number). Such transactions have certain limitations, such as daily withdrawal and/or physical machine limits. For example, a customer may desire more cash than can be accommodated by an ATM or their issuing bank's daily limitations on withdrawals from an ATM.

Systems permitting disbursement of funds so that they are available to a customer have been developed. Such systems can allow users to select a transaction and can generate an order authorizing the transaction. Accordingly, additional options for obtaining funds for entertainment have been developed. However, these systems may be of limited convenience. For example, systems may require the customer to execute portions of the transaction at different locations. The customer, for example, may be required to initiate the transaction by interacting with a venue representative at a first location and may be required to complete the transaction by endorsing a document printed at a second location. Such systems may be inefficient and disrupt the customer's enjoyment of and participation in entertainment.

### BRIEF DESCRIPTION OF THE DRAWINGS

The features, aspects and advantages of the present invention will become apparent from the following description, appended claims, and the accompanying exemplary embodiments shown in the drawings, which are briefly described below.

FIG. 1 is a drawing depicting a system for releasing funds according to one embodiment of the present invention.

FIG. 2 is a depiction of a document memorializing a transaction processed by the embodiment of FIG. 1.

FIG. 3 is a depiction of a merchant receipt of a transaction processed by the embodiment of FIG. 1.

FIG. 4 is a depiction of a cardholder receipt that memorializes a transaction processed by the embodiment of FIG. 1.

FIG. 5 is a depiction of another example of a receipt to be provided to a merchant.

FIG. 6 is a depiction of another example of a document memorializing a transaction processed by the embodiment of FIG. 1.

FIG. 7 is a block diagram of a system in accordance with another embodiment.

### DETAILED DESCRIPTION

It is to be understood that the following detailed descriptions are exemplary and explanatory only, and are not restrictive of the invention as claimed.

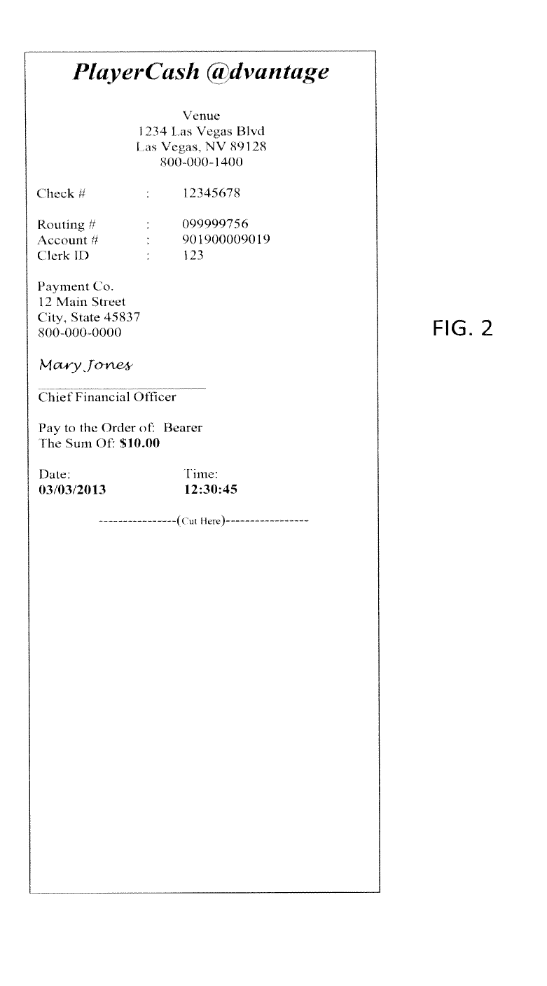

First, an overview of one embodiment of the invention will be described in connection with a casino, as an example. A customer in the casino in a gaming table area desires money for playing. In contemporary casinos, cashiers are located at fixed locations in the casino. In contrast, in this embodiment of the invention, mobile cashiers in the gaming table area are equipped with portable hand held modules. The customer approaches the mobile cashier and presents the cashier a “player” card (or other suitable device) and identification such as a driver's license. The portable module is equipped to swipe the card and has a display that displays the available transactions and that allows for the customer to select one of two or more transactions. The first transaction is a quasi-cash transaction wherein the customer buys a document that is a negotiable instrument or that is akin to a negotiable instrument using a debit or credit card (debit or credit card information has typically been provided to a service provider that provides the quasi-cash service in advance and is associated with or linked to the “player” card). FIG. 2 shows an example of such a document. The document is printed by the portable module. The document is payable to the bearer and the customer typically hands the document to a dealer in exchange for chips or cash or other items of value. Alternatively, the customer can negotiate the document at a financial institution.

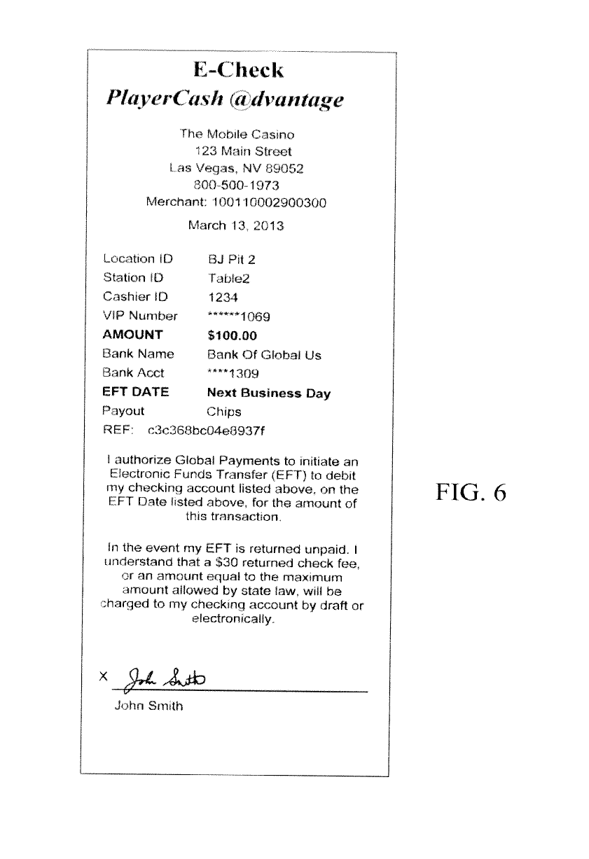

Instead of the quasi-cash transaction, the customer can elect to have funds withdrawn by electronic funds transfer (EFT) from a bank account via an automated clearing house (ACH) (bank account information has typically been provided to the service provider in advance and is associated with or linked to the “player” card). An example of a receipt for such a transaction is shown in FIG. 6.

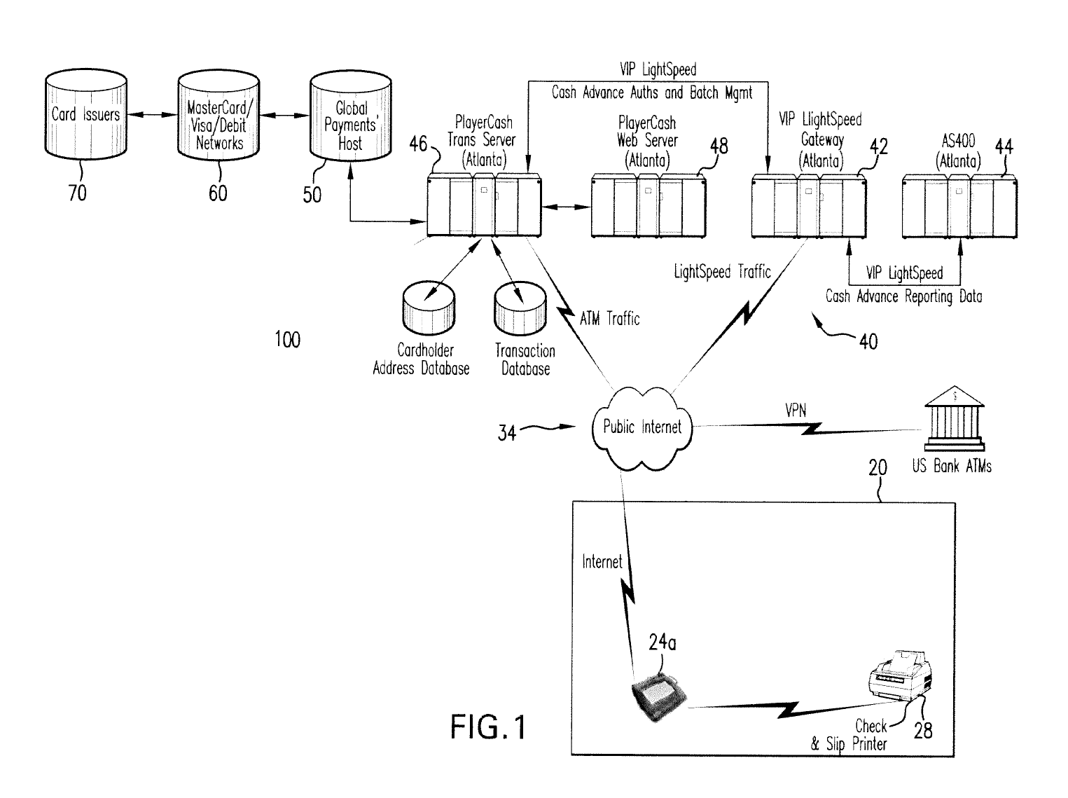

FIG. 1 illustrates one arrangement or system 100 for making funds available for entertainment. In this example, the system 100 is used and administered by a provider of quasi-cash services (as described below), which contracts with entertainment venues to provide such services to customers of the establishments. The system 100 allows a customer to purchase a document payable to the bearer that the customer can submit to readily obtain funds to use during entertainment, for example. The system 100 is configured to be accessed in an entertainment area in the venue patronized by the customer. The entertainment area may include one or more representatives providing customer service to customers therein.

The entertainment area includes at least one customer interface module 20. Each module 20 is portable and may be carried by one of the representatives. The entertainment area may have a plurality of modules 20 that are carried by representatives. The customer interface module 20 is configured to receive a card from a customer via a card insertion slot, a swipe slot, or other input device and read the customer's information from their card or from a source other than the card. The card may be, for example, a “player” card given to customers who enroll in a program that a financial services provider, such as a quasi-cash service provider, offers. Such a program, for example, may require enrollment via an application submitted at a cashier's cage, online, or to a croupier. Enrollment may include capturing microdata from the customer; for example, receiving bank account routing information, bank account numbers, credit and debit account information, billing addresses, and related information. In alternative embodiments, the card may be a conventional credit card or a debit card.

Each module 20 is configured to include a display screen 24a which serves as an input/output unit to allow the customer to select a quasi-cash transaction through the touch screen. A quasi-cash transaction is a transaction in which the customer purchases an item (e.g., a negotiable instrument) that can directly be converted into cash. Such transactions are disclosed in U.S. Pat. No. 8,140,434 (“the '434 patent,” issued on Mar. 20, 2012 to DeCristoforo), U.S. patent application Ser. No. 13/353,795 (having U.S. Patent Application Publication No. 2012/0116961 published on May 10, 2012 to DeCristoforo), and Canadian Patent Application No. 2638249 to DeCristoforo. The entire contents of the '434 patent and these patent applications are incorporated herein by reference for background information and the systems, components, processes and techniques disclosed therein. Details of portions of FIG. 1 are further described in the '434 patent.

The module 20 may be a multifunctional module which also allows the customer to make other types of transactions, such as ordering and paying for refreshments, at the customer's option. The module 20, although designed to be portable and to be accessible throughout the entertainment area, may be disposed in a single location. In some embodiments, the module 20 may be a commercially available product such as, for example, an Apple iPad® or iPOD Touch®, or any other type of mobile device.

Each module 20 is configured such that upon selection of a quasi-cash transaction through the display screen 24a, the module, after obtaining authorization from a card issuer 70 or other authority via an applicable network 60 as described below, proceeds with the quasi-cash transaction. Typically, the customer will be preapproved for a certain amount of funds. Approval for the quasi-cash transaction requires an authorization by the card issuer 70 or another authority.

A printer 28 may be formed integrally as part of the module 20. In some embodiments, the printer 28 is coupled to the module 20 wirelessly or through hardware and software connections. The printer 28 is capable of printing the documents described herein.

Each module 20 is configured to retrieve a customer's pre-approved authorization from a host system/server(s) via a network, described in further detail below, following a swipe or an insertion through a card reader of the same card that was utilized for pre-approval. The representative carrying the module 20 may optionally request information from the customer to verify and/or validate the customer's identity such as a driver's license or other acceptable photo identification. The card is electronically read and data thereon is collected and used to facilitate completion of the transaction. In some embodiments, information contained on the card, such as a card number, may be entered manually into the module 20, e.g., via a keypad or a digital image of a keypad. In some embodiments, the module 20 is configured to receive information from other than the card.

Each module 20 is configured such that after the customer's identification is verified, the module 20 queries the customer via text that appears on the display screen 24a. In some embodiments, such text may be offered in a plurality of languages. In some embodiments, the text may be supplemented or replaced with information relayed audibly, e.g., through speakers on the module 20. The text may appear in at least one embodiment on touch screen buttons that the customer presses to signify selection of the option indicated by the text.

After the customer has initiated a transaction, the module 20 is configured to query the customer whether they wish to proceed with the transaction. If the customer elects not to proceed with the transaction, the customer can cancel the transaction. Alternatively, if the customer opts to proceed with the transaction, the module 20 is configured to process the transaction, as will be described in further detail below, prior to instructing printer 28 to print out a negotiable instrument and document(s) memorializing the transaction.

If the module 20 receives an instruction that the customer wishes to proceed with an electronic transaction, the module 20 is configured to receive input about the type and amount of the transaction and to thereafter display an image of a signature block on the display screen 24a. The signature block is an area appearing on at least a portion of the display screen 24a in which the customer may be requested to place a signature or initials. A signature may be captured, for example, from a stylus or digit. The module 20 is further configured to request that the customer confirm the amount of the transaction. In some embodiments, the module is configured to request that the customer indicate acceptance of a convenience fee, e.g., by initialing or signing below the fee indicated on the display 24a.

Upon receipt of the customer's signature or initials, the display 24a may display the transaction amount and fee and may again request confirmation. The module 20 may be further configured to include other queries, protocols, and options. The display 24a may show other information in addition to the signature block.

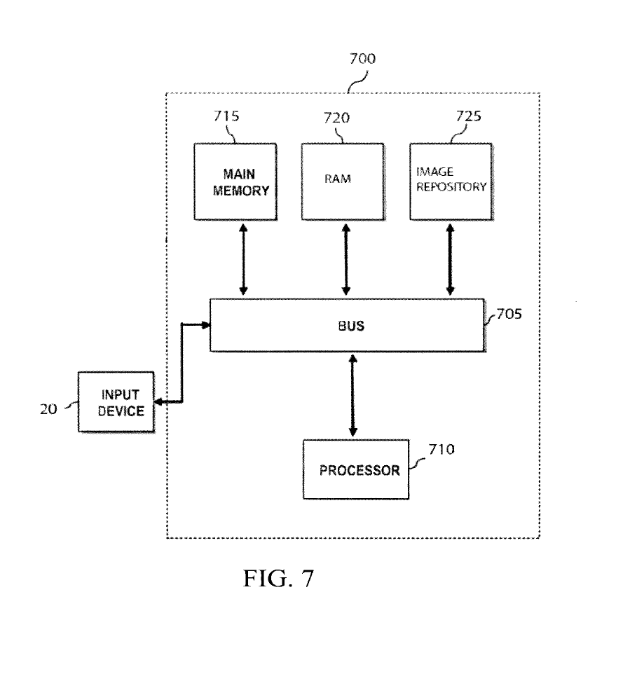

The signature or initials provided by the customer may be akin to an endorsement that signifies acquiescence to and agreement with the terms of the transaction. Once the customer proffers the signature or initials, the module 20 inserts the endorsement (i.e., the signature or initials) captured on display 24a into an image. The display 24a depicts the image containing the endorsement. The image may be stored as a file containing the endorsement. Such a file may be sent to an image repository, for example, the image repository shown in FIG. 7, as will be described below.

At any point prior to completion of the transaction, the representatives may use an image or other information on display 24a to verify the signature using identification supplied by the customer or other sources. Other verification procedures may be employed. The signature may also be verified against information contained on a server 40, discussed in further detail below.

Upon verification of the signature, the module 20 finalizes the transaction. Finalization, in some embodiments, includes production from the printer 28 of documents related to the transaction. More particularly, the documents may include data about the transaction such as time, date, location, an amount of the transaction, the customer name, and the entertainment venue. In some embodiments, the transaction may be completed at a cage or cashier station rather than at the module 20. In some embodiments, the module 20 is configured to facilitate transactions at venues other than entertainment venues.

In FIG. 2, a signature appears in a lower area above a cutaway line that may serve to separate a customer copy from a merchant copy. The signature in FIG. 2 is supplied from an officer of an authority, e.g., a financial officer from a quasi-cash service provider. As shown in FIG. 2, electronic funds are to be drawn on a bank account of the quasi-cash service provider. Thus, the document shown in FIG. 2 does not serve merely as a record of the transaction, but is also a negotiable instrument.

Upon production of a negotiable instrument or a document akin to a negotiable instrument, the customer may then choose to present the entertainment venue with the instrument. The entertainment venue then provides the customer funds for entertainment in the form of disbursed cash, chips, a marker, a ticket in/ticket out (TI/TO) slip, or items of value, for example. In some embodiments, the ticket in/ticket out (TI/TO) slip can be printed from a gaming device, such a slot machine, a cashier's cage, or the portable module 20. For example, the portable module 20 may provide an instruction to one of the gaming devices in the entertainment venue to print a TI/TO slip that has a value corresponding to the value of the transaction carried out by the customer using the portable module 20. In some embodiments, the TUTO slip may be printed out at a specified gaming device in the entertainment venue.

A record or receipt evidencing the transaction is also printed and provided to the customer to keep. Other receipts may be provided to the entertainment venue or to the quasi-cash service provider, for example. Such receipts, although they themselves memorialize the transaction, may not necessarily be negotiable instruments. Alternatively, in lieu of presenting the entertainment venue with the document, the customer may choose to negotiate the instrument at a plurality of institutions.

In some embodiments, such receipts may be e-mailed to the customer as images. Further, notifications may be provided by text message, if the customer so chooses, upon completion of a transaction.

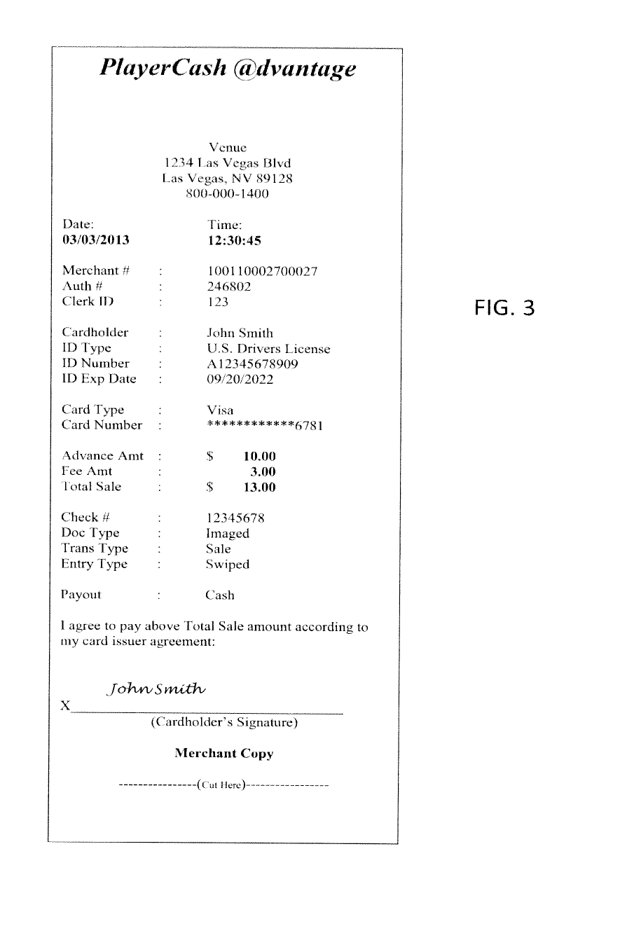

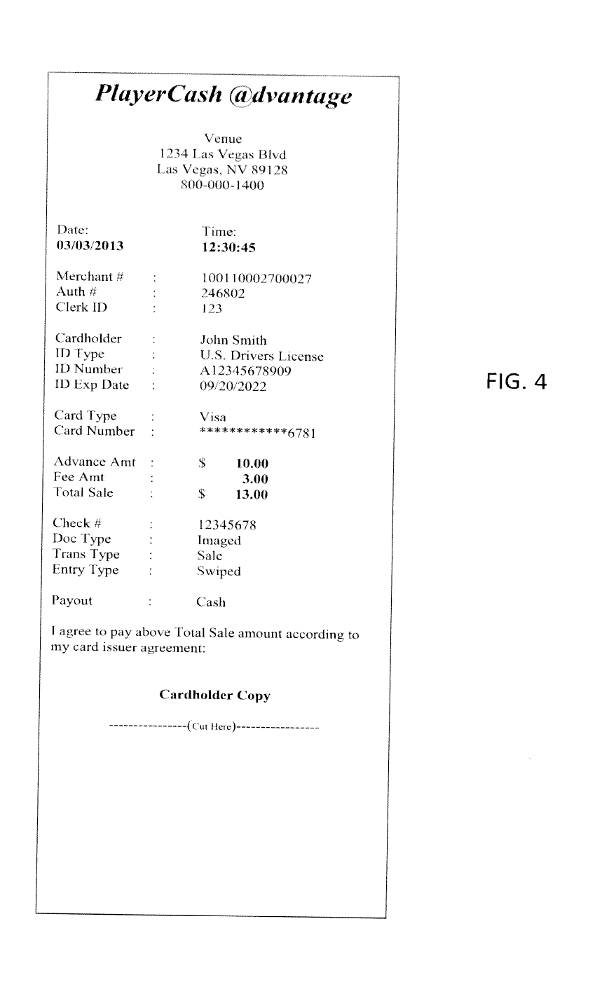

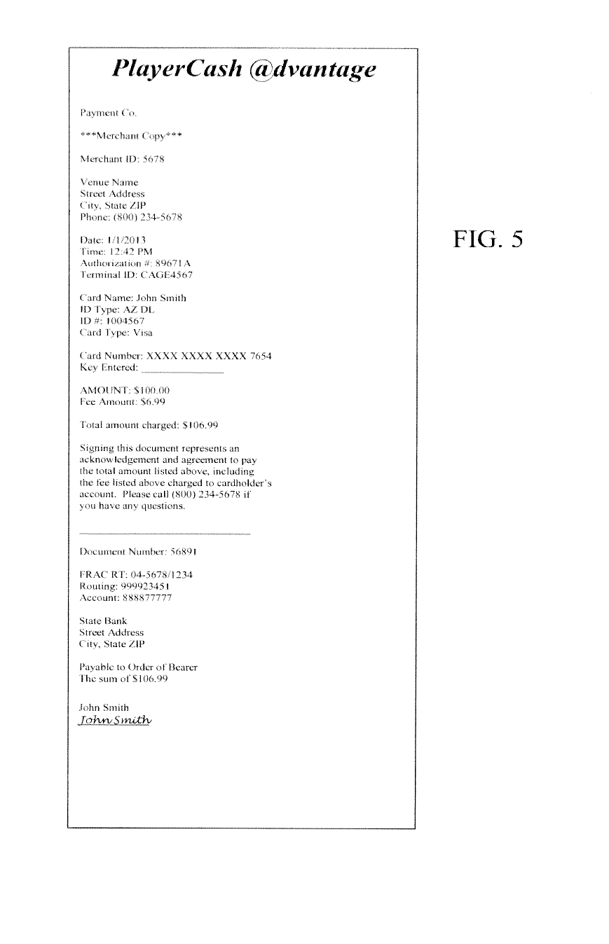

An example of a receipt is shown in FIG. 3. FIG. 3 is a depiction of a merchant receipt of a transaction generated by the embodiment of FIG. 1. FIG. 4 is a depiction of a cardholder receipt that memorializes a transaction generated by the embodiment of FIG. 1. Such a receipt would be produced, for example, for a customer for whom a debit or credit card will be drawn upon for reimbursement of the disbursed funds. FIG. 5 is a depiction of another example of a receipt to be provided to a merchant.

FIG. 6 is a depiction of an account holder document that memorializes a transaction generated by the embodiment of FIG. 1. Such a document would be produced, for example, for a customer for whom a bank account will be drawn upon for reimbursement of the disbursed funds. In some embodiments, the service provider (which provides the quasi-cash and other services available via the module) obtains reimbursement for the funds advanced to the customer via an Automated Clearing House (ACH) network. The document shown in FIG. 6 is an example of a receipt that would be generated for such a transaction.

The documents depicted in FIGS. 2-6 are illustrative examples. Other layouts, forms, styles, and configurations for the documents described above may be used. Such documents may vary in content.

Referring again to FIG. 3, the receipt contains information including credit card type, a transaction amount, a fee accepted, identification information (such as driver's license information), authorization information from the card issuer, a cardholder name and other card information. The receipt also includes the name and location of the entertainment venue where the transaction took place.

Upon presentment of the document such as the document shown in FIG. 2, the entertainment venue may deposit the document (drawn on the quasi-cash service provider's bank account) with its own bank and obtain payment via normal processing procedures as reimbursement for the funds disbursed to the customer. It will be appreciated that other payment arrangements for deposits and reimbursement may be employed.

The quasi-cash service provider serves as the merchant in the quasi-cash transaction and receives payment from the credit card issuer via the credit card networks (in the case of a credit card transaction) or from the customer's bank account via the debit networks (in the case of a debit card transaction). Such payment reimburses the quasi-cash service provider for its payment to the entertainment venue. The amount also includes the fee charged to the customer for the quasi-cash transaction, which the quasi-cash service provider may share with the entertainment venue. The quasi-cash service provider may also receive payment from a customer's bank account via an Automatic Clearing House (ACH) network rather than a credit or debit card issuer. The payment received from the ACH network provides a reimbursement to the quasi-cash service provider.

The module 20 is connected to one or more servers 40 via one or more networks, for example, network 34. In FIG. 1, the network 34 is an Internet network. As shown in FIG. 1, the system 100 has four servers 42, 44, 46, and 48 configured and programmed to perform the functions described herein. Server 42 acts as a gateway server and directs transactions from each station 20 to the other servers based on the type of transaction. For example, the card transactions described herein are directed to server 46 for processing and server 44 for reporting. Other types of transactions are directed to servers 44 and 48 for processing. FIG. 1 is only one example of one suitable arrangement and many modifications and variations are possible. The servers 40 also contains the customer information obtained from the customer during pre-enrollment, such as credit or debit card information (for quasi-cash transactions) and bank account information (for EFT/ACH transactions), as well as pre-approved limits on transaction amounts. Thus, presentation of the “player” card at the portable module 20 allows access to such information.

The servers 40 are in turn connected to networks for credit and debit card companies networks 60 via a host processor 50. The networks for the credit and debit card companies networks 60 are in turn connected to networks for the card issuers 70, who initially authorize the quasi-cash transactions. The transactions described above are thus initiated and completed directly at the module 20. In some embodiments, the server 44 communicates with the Automatic Clearing House (ACH) network to obtain reimbursement from a bank account. For example, the server 44 may aggregate data pertaining to transactions that occur on a daily basis and may send such data through the ACH network once per evening. Typically, the EFT transactions proceed via components 34, 42 and 44 in FIG. 1 and the quasi-cash transactions proceed via components 34, 46, 50, 60, and 70.

The system and method described above allow an individual to buy an item (e.g., a document that is a negotiable instrument or akin thereto) that can be directly converted into cash, in a manner similar to buying any other product or service. The system and method has the advantage in that the funds received by an individual may (depending on the issuing bank) not count against an individual's daily ATM limit or their cash advance limit. Also, certain additional charges/fees/interest (such as a higher interest rate for cash advances) may be avoided. The system and method may comply with wire transfer money order (a subset of quasi-cash) requirements for a signature in accordance with the policies and rules of financial institutions.

FIG. 7 is a block diagram of a system in accordance with another embodiment. The system 700 can be used to interface with modules such as the module 20 shown in FIG. 1. The system 700 includes a bus 705 or other communication component for communicating information and a processor 710 or processing circuit coupled to the bus 705 for processing information. The system 700 can also include one or more processors 710 or processing circuits coupled to the bus for processing information. The computing system 700 also includes main memory 715 and random access memory (RAM) 720 or other dynamic storage device, coupled to the bus 705. Main memory 715 is used for storing information and instructions to be executed by the processor 710. RAM 720 can be used for storing information, temporary variables, or other intermediate information during execution of instructions by the processor 710. The system 700 may further include a read only memory (ROM) or other static storage device coupled to the bus 705 for storing static information and instructions for the processor 710. An image repository 725, which may include a solid state device, magnetic disk or optical disk, is coupled to the bus 705 for storing images captured during transactions.

The system 700 may be coupled via the bus 705 to a display. An input device such as module 20 may be coupled wirelessly to the bus 705 for communicating information and command selections to the processor 710. The module 20 can include a digital cursor control for communicating direction information and command selections to the processor 710 and for controlling digital cursor movement on the display 24a (shown in FIG. 1).

Another embodiment of the invention is described in connection with a venue that is a gaming emporium, by way of example. A customer in the venue at a slot machine desires money for playing. Mobile cashiers are dispersed throughout the venue and generally perambulate throughout the venue. One of the mobile cashiers approaches the customer. In some embodiments, the mobile cashier is an autonomous system. The mobile cashier typically carries a device by hand. The device can be a portable module such as the portable module 20 shown in FIG. 1. In some circumstances, the mobile cashier may temporarily affix the device to a belt attachment or a fanny pack, for example, in lieu of hand-carrying it. After the mobile cashier approaches the customer, the customer presents the cashier with a “player” card (or other suitable object), and photo or biometric identification such as a driver's license or passport. The player card, for example, may be acquired upon acceptance and enrollment in a membership program. In some embodiments, a suitable object is a credit card with a Europay, Mastercard and Visa (“EMV”) chip embedded therein.

The portable module carried by the mobile cashier is equipped with at least one input element. A first input element is a display screen configured with touch pad functionality A second input element is a keypad for manually entering information such as alphanumeric data. A third input element is a card reader platform including a slot configured to receive a credit card with an EMV chip embedded therein. The third input element is further configured to process information contained on the EMV chip. A fourth input element is a laser barcode scanner configured to scan one-dimensional and/or two-dimensional bar code data.

The mobile cashier momentarily places a form of identification supplied by the customer, e.g, a driver's license, “player card,” credit card, or debit card such that it can be read, for example, by the laser barcode scanner. The laser bar code scanner derives, based on its scanning or reading of the license, various information, such as a driver's identification number, a driver name, a driver's license state of issuance, a driver's date of birth, a zip code, and a driver's license expiration date, for example. Such information is made available to software on the portable module and can be transmitted through the server 40.

In some embodiments, the portable module includes both the card reader platform and an apparatus such as an iPhone® or a Samsung Galaxy® phone. The card reader platform may be, for example, an Ingenico Smartphone Mobility Payment (“iSMP”) device into which the bar code reader is integrated. In other words, the card reader platform permits acquisition of data from both a credit card containing an EMV chip, such as an account number, and a form of identification including a bar code. The portable module also includes a keyboard for secure entry of a PIN number for transactions that require a PIN. The card reader platform may host software that communicates with a hardware-software interface of the portable module (such as an iPhone®, where the iPhone® instructs the bar code reader what to do). The software of the device may include propriety software or customized software, in addition to business platform software. The card reader platform can interface with a payment application and an operating system running on the portable module, for example. The card reader platform can further include a button that activates scanning of the bar code and/or reading of the EMV chip.

The portable module further includes a display that can depict available transactions and that allows for the customer to select one of two or more transactions. The first transaction is a quasi-cash transaction wherein the customer buys a document, such as the document shown in FIG. 2, that is a negotiable instrument or that is akin to a negotiable instrument using a credit card containing an EMV chip. The document can be printed by the device and/or e-mailed to the customer. The document is payable to the bearer and the customer typically hands the document to a dealer in exchange for chips or cash or other items of value. Alternatively, the customer can negotiate the document at a financial institution.

It will be appreciated that the device utilizes both hardware and software components in fulfilling the transaction initiated by the customer. For example, software on the device can instruct one of the hardware components, such as the bar code scanner, to collect desired data and to discard undesired data. Such software, for example, may include quality control software, verification and validation software, encryption technologies, and software to permit access to the networks 60 and servers 40 shown in FIG. 1. It will be further appreciated that data gathered through the hardware and/or software interfaces can be used during any part of the transaction and thereafter. Further, the software may receive or analyze data acquired prior to the transaction, e.g., data acquired during enrollment in a membership program.

In some embodiments, the portable module may include a combination of the above-described input elements, in any order, and some functionality of the input elements may be provided redundantly (i.e., duplicated, as when both the display's touch screen and a keypad on a side of an EMV card reader is provided. In some embodiments, such input elements may be integrated in a single portable module (e.g., within a single housing) or connected to the portable module in any combination of discrete components and/or integrated components. In some embodiments, the portable module may further include additional input elements, such as a fifth input element that is a magnetic swipe card reader that can read any type of magnetic card. A sixth input element is a speaker that permits voice-activated control of the portable module.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more non-transitory computer storage media for execution by, or to control the operation of, data processing apparatus.

The present invention is not limited to the above-described preferred embodiments. Various alternatives, modifications and equivalents may be used. Therefore, the above embodiments should not be taken as limiting the scope of the invention.

The present application claims priority to U.S. Provisional Patent Application No. 61/804,574 filed in the U.S. Patent and Trademark Office on Mar. 22, 2013. The contents of this application are incorporated herein by reference in their entirety.

1. A system for disbursing funds, the system comprising:
a portable module configured to process customer information, thereby allowing a customer to select at least one of a plurality of transactions, one of the transactions being a quasi-cash transaction;
at least one input device coupled to or formed in the portable module, the at least one input device being configured to capture an electronic endorsement from the customer and to generate an image therefrom;
an output device coupled to or formed in the portable module, the output device being configured to create a negotiable instrument for the quasi-cash transaction,
wherein a transaction culminates in disbursement of funds.

2. The system of claim 1, wherein the portable module generates a request for the transaction, the request comprising customer information that is verified prior to disbursement of funds.

3. The system of claim 1, wherein the portable module is further configured to e-mail a record memorializing the transaction.

4. A method for disbursing funds, the method comprising:
processing customer information in a portable module;
allowing a customer to select at least one of a plurality of transactions, including a quasi-cash transaction;
obtaining an electronic endorsement from the customer and generating an electronic image therefrom, and
creating a negotiable instrument for the quasi-cash transaction.

5. The method of claim 4, further comprising:
generating a request for the quasi-cash transaction, and
verifying information therein prior to disbursement of funds.

6. The method of claim 4, further comprising transmitting quasi-cash information over a wireless network.

7. A method for making funds available for entertainment, the method comprising:
reading customer information from a card at a terminal within an entertainment area;
allowing the customer to select a quasi-cash transaction at the terminal and generating an order authorizing the quasi-cash transaction when the customer selects the quasi-cash transaction;
retrieving the order and information verifying an identity of the customer on a handheld mobile device;
displaying an option to the customer, when the identity of the customer is verified, on a display included on the hand held mobile device that allows the customer to select, at the customer's option, after the identity of the customer is verified, (1) an electronic endorsement from the customer and placement of the electronic endorsement in an electronic image or (2) a printout of a hard copy of the electronic image, which represents a negotiable instrument and which, at the customer's election, may be printed for presentment for cash, casino chips, a ticket in, ticket out (“TITO”) slip, whether printed from a gaming device or a cage, or any equivalent thereof;
wherein the display includes a customer input device and the customer input device asks the customer to select (1) or (2) and receives the customer's selection of (1) or (2) as input,
wherein if the customer chooses the hard copy, the hand held mobile device is configured to print or issue an instruction to a printer to print the hard copy, and
wherein if the customer chooses the electronic endorsement, the display is configured to ask the customer if the transaction is acceptable and to initial the display with a stylus such that after the customer makes the electronic endorsement, the handheld mobile device is configured to insert the endorsement on the display into the electronic image, and the handheld mobile device is further configured to transfer the electronic image to an image repository.

8. The method of claim 7, further comprising printing out a receipt by the handheld mobile device or, at the customer's option, emailing an image of the receipt to the customer.

9. The method of claim 7, wherein the electronic endorsement is not separated from other portions of the electronic image.

10. A system for making funds available for entertainment, the system comprising:
a terminal included in an entertainment area which is configured to read customer information from a card, the terminal including an interface unit configured to allow a customer to select a quasi-cash transaction and to generate an order authorizing the quasi-cash transaction;
retrieving the order and information verifying an identity of the customer on a handheld mobile device; and, once the identity of the customer is verified, a display included in the handheld mobile device allows the customer to input an electronic endorsement,
displaying an option to the customer, when the identity of the customer is verified, on a display included on the handheld mobile device that allows the customer to select, at the customer's option, after the identity of the customer is verified, (1) an electronic endorsement from the customer and placement of the electronic endorsement in an electronic image, or (2) a printout of a hard copy of the electronic image, which represents a negotiable instrument and which, at the customer's election, maybe printed for presentment for cash, casino chips, a ticket in, ticket out (“TITO”) slip, or any equivalent thereof;
wherein the display includes a customer input device and the customer input device asks the customer to select (1) or (2) and receives the customer's selection of (1) or (2) as input,
wherein if the customer chooses the hard copy, the handheld mobile device is configured to print or issue an instruction to a printer to print the hard copy, and
wherein if the customer chooses the electronic endorsement, the display is configured to ask the customer if the transaction is acceptable and to initial the display with a stylus such that after the customer makes the electronic endorsement, the hand held mobile device is configured to insert the endorsement on the display into the electronic image, and the handheld mobile device is further configured to transfer the electronic image to an image repository.

11. The system of claim 10, wherein the handheld mobile device is configured to obtain electronic initials from the customer.

12. The system of claim 10, wherein the handheld mobile device is configured (1) to print, or issue an instruction to a printer to print, out a receipt, or, (2) at the customer's option, to email an image of the receipt to the customer.

13. The system of claim 10, wherein a hard copy of the electronic image represents a negotiable instrument, which at the customer's election, maybe printed for presentment for cash, casino chips, a TITO slip, or any equivalent thereof.

14. The system of claim 10, wherein the electronic image comprises customer information and the electronic endorsement.

15. A method for making funds available for entertainment, the method comprising:
reading customer information on a handheld mobile device;
allowing the customer to select a quasi-cash transaction from the handheld mobile device and generating an order authorizing the quasi-cash transaction when the customer selects the quasi-cash transaction;
retrieving the order and information verifying an identity of the customer on a handheld mobile device;
displaying an option to the customer, when the identity of the customer is verified, on a display included on the handheld mobile device that allows the customer to select, at the customer's option, after the identity of the customer is verified, (1) an electronic endorsement from the customer and placement of the electronic endorsement in an electronic image or (2) a printout of a hard copy of the electronic image, which represents a negotiable instrument and which, at the customer's election, maybe printed for presentment for cash, casino chips, a TITO slip, or any equivalent thereof;
wherein the display includes a customer input device and the customer input device asks the customer to select (1) or (2) and receives the customer's selection of (1) or (2) as input,
wherein if the customer chooses the hard copy, the hand held mobile device is configured to print or issue an instruction to a printer to print the hard copy, and
wherein if the customer chooses the electronic endorsement, the display is configured to ask the customer if the transaction is acceptable and to initial the display with a stylus such that after the customer makes the electronic endorsement, the hand held mobile device is configured to insert the endorsement on the display into the electronic image, and the handheld mobile device is further configured to transfer the electronic image to an image repository.

16. The method of claim 15, further comprising printing out a receipt by the hand held mobile device or, at the customer's option, emailing an image of the receipt to the customer.

17. The method of claim 15, wherein the electronic endorsement is not separated from other portions of the electronic image.

18. A system for making funds available for gaming, the system comprising:
a handheld mobile device which is configured to read customer information from a card, the handheld mobile device including an interface unit configured to allow a customer to select a quasi-cash transaction and to generate an order authorizing the quasi-cash transaction,
wherein the handheld mobile device is further configured to:
retrieve the order and information verifying an identity of the customer on a hand held mobile device; and when the identity of the customer is verified, on a display included in the hand held mobile device allows the customer to input an electronic endorsement, and
display an option to the customer, when the identity of the customer is verified, on a display included on the hand held mobile device that allows the customer to select, at the customer's option, after the identity of the customer is verified, (1) an electronic endorsement from the customer and placement of the electronic endorsement in an electronic image or (2) a printout of a hard copy of the electronic image, which represents a negotiable instrument and which, at the customer's election, maybe printed for presentment for cash, casino chips, a ticket in, ticket out (“TITO”) slip, or any equivalent thereof,
wherein the display includes a customer input device and the customer input device asks the customer to select (1) or (2) and receives the customer's selection of (1) or (2) as input,
wherein if the customer chooses the hard copy, the hand held mobile device is configured to print or issue an instruction to a printer to print the hard copy, and
wherein if the customer chooses the electronic endorsement, the display is configured to ask the customer if the transaction is acceptable and to initial the display with a stylus such that after the customer makes the electronic endorsement, the handheld mobile device is configured to insert the endorsement on the display into the electronic image, and the handheld mobile device is configured to transfer the electronic image to an image repository.

19. The system of claim 18, wherein the handheld mobile device is configured to obtain electronic initials from the customer.

20. The system of claim 18, wherein the handheld mobile device is configured to (1) to print, or issue an instruction to a printer to print, a receipt, or, (2) at the customer's option, to email an image of the receipt to the customer.

21. The system of claim 18, wherein a hard copy of the electronic image represents a negotiable instrument, which at the customer's election, maybe printed for presentment for cash, casino chips, a TITO slip, or any equivalent thereof.

22. The system of claim 18, wherein the electronic image comprises customer information and the electronic endorsement.

23. A method for making funds available for gaming, the method comprising:
providing a handheld mobile device configured to read customer information from a card, the hand held mobile device including an interface unit configured to allow an electronic check transaction comprising an Automated Clearing House transaction;
reading customer information from a card on a hand held mobile device;
verifying an identity of the customer on a hand held mobile device; and when the identity of the customer is verified, on a display included in the hand held mobile device allows the customer to input an electronic endorsement,
wherein the display is configured to ask the customer if the transaction is acceptable and to initial the display with a stylus such that after the customer makes the electronic endorsement the hand held mobile device is configured to insert the endorsement on the display into the electronic image, and the hand held mobile device is configured to transfer the electronic image to an image repository.

24. The method of claim 23, further comprising printing out a receipt by the hand held mobile device or, at the customer's option, emailing an image of the receipt to the customer.

25. The method of claim 23, wherein the electronic endorsement is not separated from other portions of the electronic image.

26. A system for making funds available for gaming, the system comprising:
a hand held mobile device configured to read customer information from a card, the hand held mobile device including an interface unit configured to allow an electronic check transaction comprising an Automated Clearing House transaction,
wherein customer information from a card is read by the hand held mobile device,
wherein an identity of the customer is verified by the hand held mobile device, wherein, when the identity of the customer is verified, a display included in the handheld mobile device allows the customer to input an electronic endorsement,
wherein the display is configured to ask the customer if the transaction is acceptable and to allow the customer to initial the display with a stylus such that after the customer makes the electronic endorsement, the handheld mobile device is configured to insert the endorsement on the display into the electronic image,
wherein the handheld mobile device is further configured to transfer the electronic image to an image repository.

27. The system of claim 26, wherein the hand held mobile device is configured to obtain electronic initials and an electronic signature from the customer.

28. The system of claim 26, wherein the hand held mobile device is configured (1) to print, or issue an instruction to a printer to print, a receipt, or, (2) at the customer's option, to email an image of the receipt to the customer.

29. The system as set forth in claim 26, wherein the electronic image comprises customer information and the electronic endorsement.
